(19) United States
(12) Patent Application Publication
(10) Pub. No.: US 2006/0236571 A1
(43) Pub. Date: Oct. 26, 2006

(54) Animated tree

(76) Inventor: Sheila Tipay, Wheeling, IL (US)

Correspondence Address: Paul L. Brown;Emrich & Dithmar LLC, Suite 2080, 125 South Wacker Drive, Chicago, IL, 60606-4401, US

(21) Appl. No.: 11/449,065

(22) Filed: Jun. 8, 2006

Related U.S. Application Data
(63) Continuation of application No. 10/705,442, filed on Nov. 10, 2003, now abandoned.
(60) Provisional application No. 60/425,430, filed on Nov. 12, 2002.

(51) Int. Cl. G09F 19/08

(52) U.S. Cl. 40/411

(57) ABSTRACT

An animated Christmas tree includes a trunk member having a plurality of openings and an actuating member positioned within the trunk member and extending substantially the length thereof and being operable between an extended position and a collapsed position. A plurality of flexible tree branches are anchored to the actuating member and extend outwardly from the trunk member. Upon movement of the actuating member in the trunk member, the tree branches move between the collapsed position and the extended position.

### CROSS-REFERENCE TO RELATED PATENT APPLICATIONS

This application claims priority to provisional patent application No. 60/425,430, filed on Nov. 12, 2002.

### BACKGROUND OF THE INVENTION

The present invention relates to an animated tree and, in particular, to an animated Christmas tree which includes branches which are movable between a substantially collapsed position and a substantially full, expansive position.

The affinity that children and adults have during the holiday season with respect to the decoration of Christmas trees is well known. Indeed, attempts have been made to animate Christmas displays to supplement the attraction children and adults have of Christmas trees. Such displays are provided, for example, in U.S. Pat. No. 2,874,496 and in U.S. Pat. No. 5,664,351. In these prior art patents, the Christmas tree is either designed to rotate about a fixed axis or is mounted to a carriage assembly for back and forth movement along a track assembly. The purpose of such displays is to cause the deployed Christmas tree to either rotate or travel back and forth to supplement the entertainment for children and adults. However, such limited movements of a tree do not provide the image of a living tree or simulate the movement of a living tree.

### SUMMARY OF THE INVENTION

Accordingly, it is desirable to provide an animated tree that is movable from a closed position to a full, expansive position to provide the appearance that the tree is animated and is a living tree and to provide entertainment for the viewer.

It is a further object of the present invention to provide a motor driven, animated tree which is movable between a collapsed position wherein the branches are closely positioned adjacent the tree trunk to a full, expansive position wherein the tree branches extend outwardly from the tree trunk to provide a full bodied or expanded tree.

The present invention relates to an animated tree which includes a trunk member having a plurality of openings therein. The openings may include an upper engaging surface and a lower engaging surface which surfaces engage the tree branches during animation, as will hereinafter be described. An actuating member is positioned within the trunk member to extend substantially the length of the trunk member. The actuating member is operatively connected to a drive motor or member and is operable between an extended position and a collapsed position. The drive shaft of the motor member is keyed to a first linkage member which rotates with the motor driven drive shaft. A second linkage is coupled to the actuating member and to the first linkage member. The purpose of the linkages to the drive motor is to convert the rotary motion of the shaft to a linear motion to reciprocate the actuating member between an upward, extended position and a downward, collapsed position.

A plurality of flexible tree branches are positioned through the plurality of openings in the trunk member, with the proximal ends of the branches, preferably, being secured and anchored to the axially movable actuating member. The distal ends of the tree branches extend outwardly through the opening from the trunk member. When the actuating member is in the upper, extended position, the flexible tree branches engage the upper side wall of the openings. The force upon the flexible branches forces the distal ends of the branches to extend downwardly, such that the branches are in a collapsed position. When the actuating member is moved downwardly, the mounted proximal ends of the branches move downward with the actuating member and away from the upper side wall of the opening. During the downward movement, the tree branches will partially open and extend radially outwardly from the tree trunk. When the tree branches engage the lower side wall of the plurality of openings, the engagement forces the distal ends of the branches to extend upwardly and outwardly to provide a full-sized, animated tree.

The present invention consists of certain novel features and structural details hereinafter fully described, illustrated in the accompanying drawings, and particularly pointed out in the appended claims, it being understood that various changes in the details may be made without departing from the spirit or sacrificing any of the advantages of the present invention.

### DESCRIPTION OF THE DRAWINGS

For the purpose of facilitating an understanding of the present invention, there is illustrated in the accompanying drawings a preferred embodiment thereof, from an inspection of which, when considered in connection with the following description, the invention, its construction and operation, and many of its advantages will be readily understood and appreciated.

FIG. 1 is a perspective view of the animated tree showing the full expansion of a tree in accordance with the present invention;

FIG. 2 is a perspective view of the animated tree showing the intermediate positioning of the branches of the tree in accordance with the present invention during movement from a collapsed position to the full expansion position;

FIG. 3 is a perspective view of the animated tree in accordance with the present invention in the collapsed position;

FIG. 4 is a cross-sectional side view of the drive mechanism coupled to the actuating member in the collapsed position;

FIG. 5 is a cross-sectional view of the drive mechanism for reciprocating the actuating member in the full, extended position;

FIG. 6 is a side view of the invention illustrated in FIG. 4;

FIG. 7 is a side view of the invention illustrated in FIG. 5;

FIG. 8 is a sectional view of a further embodiment of the present invention illustrating the positioning of the flexible tree branches when the actuating member is in the collapsed, downward position;

FIG. 9 is a sectional view of the embodiment of the present invention illustrating the positioning of the actuating member in an extended position wherein the flexible branches are in the full, extended position;

FIG. 10 is cross-sectional view of a further embodiment of the present invention wherein the animated tree includes flexible branches that move from a collapsed to an extended position to increase the height of the tree;

FIG. 11 is a cross-sectional view of the an embodiment of the invention of FIG. 10 illustrating the positioning of the flexible branches in a collapsed position to decrease the height of the tree;

FIG. 12 is a sectional view of a further embodiment of the drive mechanism when the actuating member is in the downward position; and

FIG. 13 is a sectional view of the embodiment shown in FIG. 12 when the actuating member is in the extended position.

### DESCRIPTION OF THE EMBODIMENTS

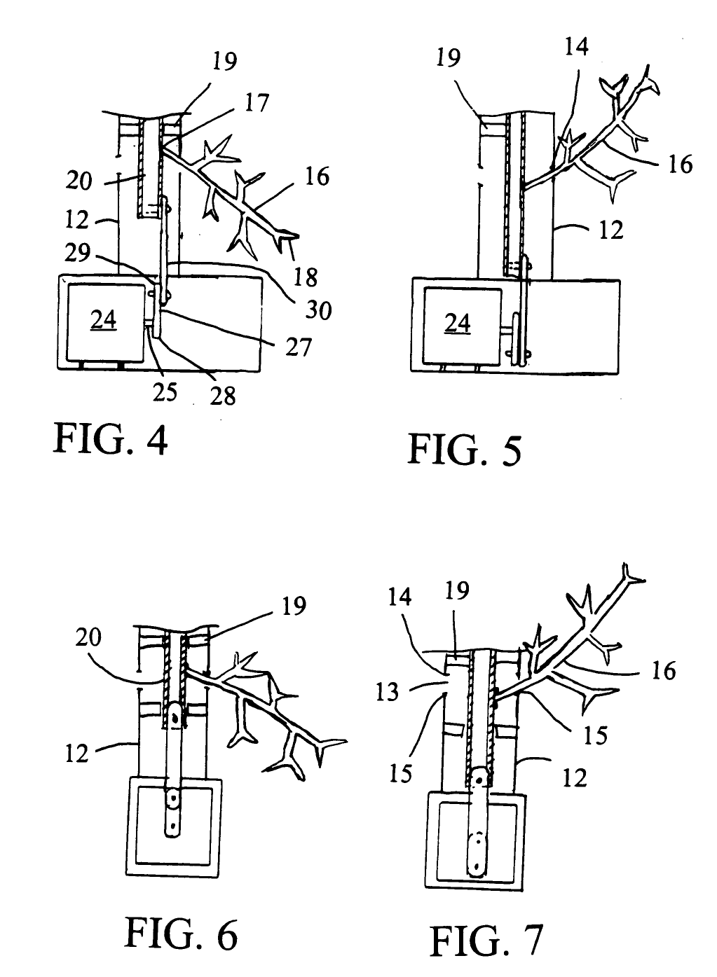

Referring now to the drawings wherein like numerals have been used throughout the several views to designate the same or similar parts, an animated Christmas tree 10 embodying the principles of the present invention is shown. The animated Christmas tree 10 in accordance with the present invention includes a tubular trunk member 12 having a plurality of openings 13 therein which extend from the base of the tree trunk to the upper end of the tree. The trunk member may be a molded plastic or wire mesh material. The openings 13 are predeterminely located about in the tubular trunk member 12 from the lower end of the trunk 12 to the upper end of the tree trunk. As shown in FIGS. 4-7, the plurality of openings 13 in the tubular trunk member 12 include an upper engaging surface 14 and a lower engaging surface 15, which surfaces are structurally arranged to engage the flexible tree branches 16 during the relative movement of the actuating member 20 within the trunk, as will hereinafter be described. The flexible tree branches 16 include a proximal end 17 which is anchored or secured to the trunk member or to the actuating member 20 positioned within the trunk and a distal end 18 which extends outwardly from the tree trunk member 12. The branches may be anchored or secured to the actuating member or trunk member by an adhesive, a strap member, a fastener such as Velcro, or by wedging.

As shown in FIGS. 4-13, a movable actuating member 20 is positioned within the tree trunk 12. The tree trunk 12 includes guide members 19 positioned therein which confine and retain the actuating member 20 in substantially a vertical position within the trunk. The actuating member 20 is structurally arranged to move between upward and downward positions relative to the trunk member to provide the animated feature of the present invention, as will hereinafter be described.

The actuating member 20 is positioned within the tubular trunk member 12 within the aligned guide members 19 positioned on the inside of the trunk member. The actuating member 20 extends substantially the length of trunk member 12 and is operable between an extended, upward position and a collapsed, downward position. The actuating member is operatively connected for such up and down movement to a drive motor or member 24. In one embodiment of the present invention, the drive shaft 25 of the motor member 24 is keyed to a first linkage member 27 which is mounted to and rotates with the motor driven drive shaft 25. The first linkage member has a first end 28 secured to the drive shaft 25 and a second end 29 secured to a second linkage member 30. The second end 32 of the second linkage member 30 is secured to the bottom 40 of the movable actuating member 20.

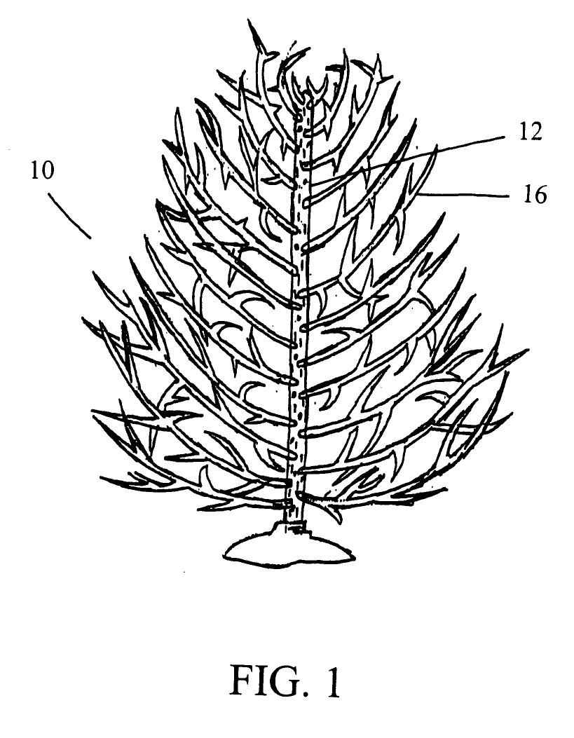

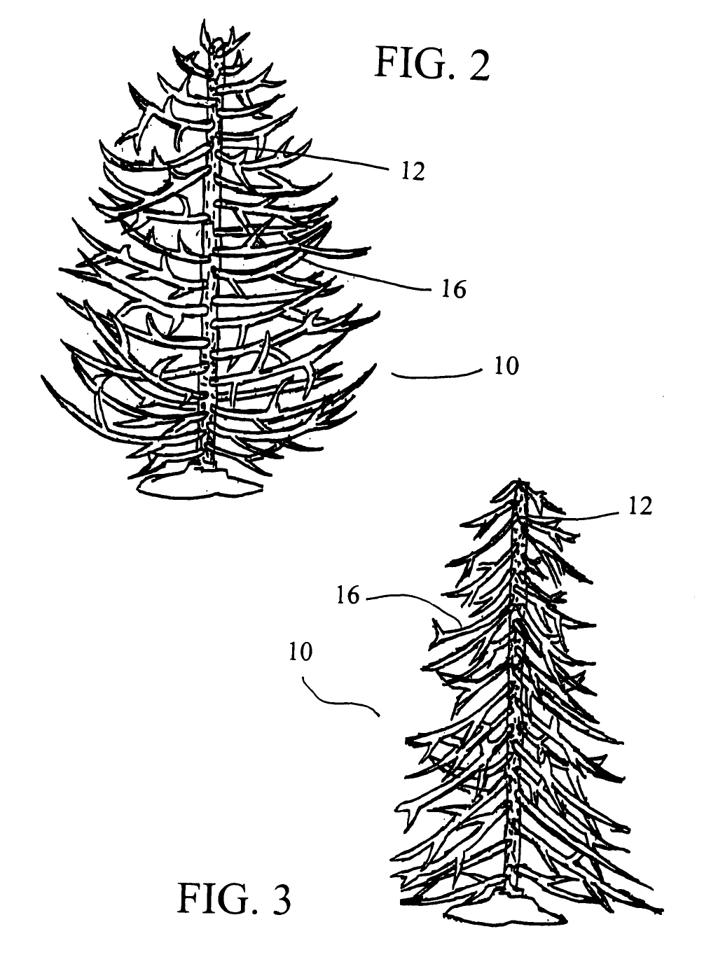

Thus, upon the slow and precise rotation of the drive shaft 25, the first and second linkage members are structurally arranged, as shown in FIGS. 4-7, to raise the actuating member to an upward position, as shown in FIGS. 4 and 6, from the downward, collapsed position, as shown in FIGS. 5 and 7. The movement of the actuating member 20 and the attached flexible tree branches causes the flexible tree branches to engage the upper engaging surface 14 of the opening when the actuating member is in the upward position, as shown in FIGS. 4 and 6, and to engage the lower engaging surface 15 when the actuating member is in the downward, collapsed position, as shown in FIGS. 5 and 7. This results in an animated movement of the tree to move from the position, as shown in FIG. 3, to the position, as shown in FIG. 1. Importantly, the drive motor may be controlled by switch means to stop the rotation of the motor means at any desired position to control the size or growth of the tree, which results from the extension of the flexible tree branches through the openings in the trunk member 12. Also, it is preferred that the time for movement of the actuating member between the collapsed and extended positions is between about 10 seconds to 5 minutes.

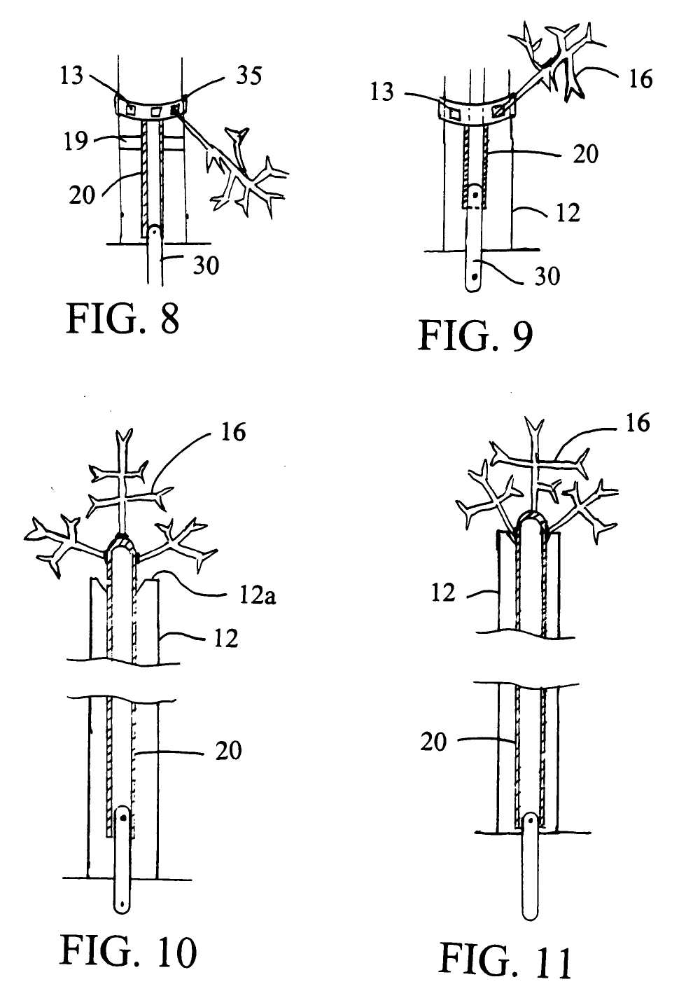

FIGS. 8 and 9 depict a further embodiment of the present invention wherein the movable actuating member 20 is operatively coupled to a sleeve member 35. The sleeve 35 which is structurally arranged to move upwardly and downwardly relative to the trunk member 12 when the actuating member moves between an upward and downward position. The sleeve member may be positioned outside the trunk member 12, as shown in FIGS. 8 and 9, or may be slidably positioned within the tree trunk to cooperate with the tree branches. The upward movement of the actuating member 20 and the sleeve 35 is shown in FIG. 9. Specifically, FIG. 9 illustrates that the proximal end of the flexible tree branch may be secured to the inside surface of the trunk member and that the openings 13 in the sleeve member 35 cooperate with the flexible tree branches to provide that when the actuating member is in an upward, extended position, the tree branches are forced by the engagement with openings 13 to move to the upward position, as shown in FIG. 9 to provide a full, expanded Christmas tree. When the actuating member is in the lower, collapsed position, the openings 13 in the sleeve member 35 engage the flexible tree branches to cause the tree branches to collapse toward the tree trunk. This is the position as generally depicted in FIG. 3 of the present invention.

Also, the tree may include structures wherein the upward movement of the actuating member may extend above the end 12a of the tubular trunk member 12. Thus, when the actuating member is in the downward position, as shown in FIG. 11, branches attached to the actuating member are collapsed inwardly by engagement with the end 12a of the trunk member. When the actuating member is moved upwardly, as shown in FIG. 10, the flexible branches expand and the top of the tree appears to grow in length when the actuating member is in the upward position. Thus, the structure in accordance with the present invention provides a structure wherein the tree can be moved from a collapsed to a full, extended position and one in which the height of the tree is increased when this expansion occurs.

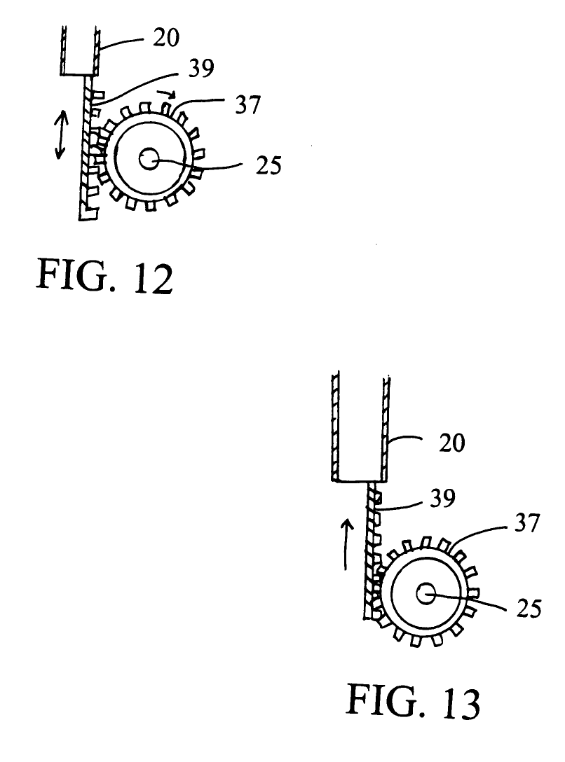

A further embodiment of the present invention is shown in FIGS. 12 and 13. The motor shaft or drive shaft 25 includes a pinon gear 37 is structurally arranged to mesh with a linear gear 39 mounted to the lower end of the actuating member 20. This provides a gear driving mechanism for the actuating member. Upon rotation of the pinon gear, the linear gear moves relative to the pinon gear, and the actuating member is moved upwardly or downwardly, as desired. In such an embodiment, the motor member 24 includes a reversible drive output to drive the linear gear in an up and down fashion.

The controlled rotation of the drive shaft of the drive member or motor 24 controls the rate at which the articulated Christmas tree moves from a collapsed position, as shown in FIG. 3 to a full, expanded position, as shown in FIG. 1. It is preferred that this movement from a collapsed to an extended position or the movement from the extended position to a collapsed position should occur over a short period of time to increase the animation of the tree to the observer. It is preferred that the timing of this movement between the extended and collapsed position should occur within 10 seconds to 5 minutes to provide the effect of an animated tree.

1. An animated tree including in combination:
a trunk member having a plurality of openings therein, with said openings having an upper engaging surface and a lower engaging surface;
an actuating member positioned within said trunk member and extending substantially the length thereof, said actuating member being operable between an extended, upward position and a collapsed, downward position;
a plurality of flexible tree branches extending through said predetermined openings in said trunk member, with said branches having a proximal end anchored to said actuating member and having a distal end extending outwardly from said trunk member through said openings;
wherein when said actuating member is in said extended, upward position, said flexible tree branches contact said upper engaging surface of said openings to force said distal ends of said branches to extend downwardly to the collapsed position, and when said actuating member is in said collapsed position said tree branches contact said lower engaging surfaces of said openings to force said distal ends of said branches to move to an extended position to provide a full sized animated tree.

2. The animated tree in accordance with claim 1, wherein said actuating member is driven by a motor member.

3. The animated tree in accordance with claim 2, wherein said output of said motor member is a rotating drive shaft.

4. The animated tree in accordance with claim 3, wherein said rotating drive shaft is linked to said actuating member to drive the same.

5. The animated tree in accordance with claim 4, wherein said linkage is a pair of linkage members coupled together to provide up or down forces on said actuating member to move the same between said upward and said downward positions.

6. The animated tree in accordance with claim 4, wherein said linkage includes a pinion gear rotatable with said drive shaft of said motor member and a linear gear mounted to said actuating member, with said gears meshing together to move the actuating member between said upward and said downward positions.

7. The animated tree in accordance with claim 1, wherein said trunk member includes guide members mounted therein to retain said actuating member in alignment with said trunk member.

8. The animated tree in accordance with claim 1, wherein said movement between said extended position and said collapsed position is between 10 seconds to 5 minutes.

9. An animated tree including in combination:
a trunk member having a plurality of openings therein, with said openings being structurally arranged;
an actuating member positioned within said trunk member and extending substantially the length thereof, said actuating member being operable and driven between an extended, upward position and a collapsed, downward position;
a plurality of sleeve members associated with said actuating member and structurally arranged to cooperate with said trunk member and said openings therein;
a plurality of flexible tree branches extending through said openings in said trunk member, with said branches having a proximal end anchored to said trunk member and having a distal end extending outwardly from said trunk member through said openings in said trunk member and said sleeve members;
wherein said actuating member is in said extended, upward position, said flexible tree branches are contacted by said sleeve members to force said distal ends of said branches to an extended position, and when said actuating member is in said collapsed position said tree branches are contacted by said sleeve members to force said distal ends of said branches to move to a downward, collapsed position.

10. The animated tree in accordance with claim 9, wherein said actuating member is driven by a motor member.

11. The animated tree in accordance with claim 10, wherein said output of said motor member is a rotating drive shaft.

12. The animated tree in accordance with claim 11, wherein said rotating drive shaft is linked to said actuating member to drive the same.

13. The animated tree in accordance with claim 12, wherein said linkage is a pair of linkage members coupled together to provide up or down forces on said actuating member to move the same between said upward and said downward positions.

14. The animated tree in accordance with claim 12, wherein said linkage includes a pinion gear rotatable with said drive shaft of said motor member and a linear gear mounted to said actuating member, with said gears meshing together to move the actuating member between said upward and said downward positions.

15. The animated tree in accordance with claim 9, wherein said trunk member includes guide members mounted therein to retain said actuating member in alignment with said trunk member.

16. The animated tree in accordance with claim 9, wherein said movement between said extended position and said collapsed position is between 10 seconds to 5 minutes.

17. The animated tree in accordance with claim 9, wherein said actuating member includes an upper end portion that extends beyond said trunk member when in said extended, upward position.
